(19) United States
(12) Patent Application Publication
(10) Pub. No.: US 2006/0137869 A1
(43) Pub. Date: Jun. 29, 2006

(54) Method for producing heat exchanger tubes, which consist of half-tubes or complete tubes and which are provided for recuperative exhaust gas heat exchanger

(76) Inventor: Ludwig Steinhauser, Maisach (DE)

Correspondence Address: KENYON & KENYON LLP, ONE BROADWAY, NEW YORK, NY, 10004, US

(21) Appl. No.: 10/540,226

(22) PCT Filed: Nov. 26, 2003
(86) PCT No.: PCT/DE03/03917

§ 371 Date: Dec. 27, 2005

(30) Foreign Application Priority Data
Dec. 21, 2002 (DE) 102 60 535.1

(51) Int. Cl. F28F 9/02; B23P 15/26

(52) U.S. Cl. 165/173; 29/890.052

(57) ABSTRACT

In a process for the production of half-tubes or tubes of a recuperative waste gas heat exchanger using a precision casting process, the half-tubes or tubes consisting of a high-temperature-resistant metallic material have a plurality of elliptical openings passing through their surface.

### FIELD OF THE INVENTION

The present invention relates to a process for the production of half-tubes or tubes of a metallic, high-temperature-resistant material with a plurality of openings passing through their surface, for the fabrication of heat exchanger tubes for recuperative waste gas heat exchangers, as well as half-tubes/tubes produced by this process.

### BACKGROUND INFORMATION

As is conventional, the recuperative waste gas heat exchangers used in gas turbine plants include, in addition to a heat exchanger housing, a distributor tube for feeding the “cold” air conveyed from a compressor into a so-called cross-counterflow matrix through which hot turbine waste gas flows, and a collecting tube for passing the now heated-up “hot” compressor air to a suitable consumer, for example, the combustion chamber of the gas turbine plant. For simplicity, the distributor tube as well as the collecting tube will hereinafter also be referred to as heat exchanger tube.

The feeding of the air from the distributor tube into the cross-counterflow matrix and the discharge of the air from the cross-counterflow matrix into the collecting tube is effected by a plurality of openings made in the surface of the heat exchanger tubes.

The cross-counterflow matrix includes a plurality of elliptical lancets or small tubes assembled to form a tubular bundle. The tubular bundle is arranged laterally and protruding in a U-shaped manner on the heat exchanger tubes arranged in parallel, the ends of each small tube of the tubular bundle corresponding in each case to an opening made in the surface of the heat exchanger tubes. In order to be able to achieve the desired throughput, a plurality of lancets and accordingly a plurality of openings/holes are necessary in the surface of the heat exchanger tubes.

The heat exchanger tubes consisting of a high-temperature-resistant material have been assembled from forged half-tubes. The joining of two half-tubes to form a heat exchanger tube is effected by welding, and the attachment of the lancets to the heat exchanger tubes is effected by high-temperature soldering.

According to a typical of a half-tube of length 500 mm and radius 62.5 mm, rows of holes each including 184 openings are provided on 19 circumferential positions, so that per half-tube a total of 3,496 openings are formed in the surface. For the production of the heat exchanger tubes of a recuperative waste gas heat exchanger from half-tubes, 4×3,496=13,984 holes/openings are therefore necessary in the surface of the half-tubes.

The formation of such a large number of openings in the surface of the forged half-tubes proves to be extremely cost-intensive and time-consuming.

The formation of the openings in the surface of the half-tubes has therefore been achieved by spark erosion (EDM=electrodischarge machining). EDM is a conventional method for producing holes or other openings in metals. The principle of the method, namely the thermal abrasion of small volumes by the high power density of a locally penetrating arc in the liquid dielectric acting on the anode (workpiece), involves a melting of the material in microscopic dimensions.

Apart from the high cost, the EDM process has a further disadvantage. Due to the process-dependent procedure involved in the forming of the openings in the surface of the heat exchanger tubes re-solidified layers, the so-called recast layers, are formed in the region of the perforation walls on the workpieces. These layers have to be removed before the high-temperature soldering to be carried out subsequently for soldering the lancets into the half-tubes, which proves to be a disadvantage and is complicated. The narrow soldering gaps and small tolerances (±0.05 mm) required for the high-temperature soldering often cannot be achieved with existing recast layers for economic reasons (a slow fine processing stage is necessary).

Electrochemical processing (ECM=electrochemical machining) is another option for forming the openings in the surface of the half-tubes. This method is costly however in terms of installation and tooling, and has capital-intensive equipment costs.

Also, the electrolyte in this process is typically an oxidizing agent, for example, sodium nitrate or sodium chloride, which constitutes a health and security risk, and the by-products of the process are classified as toxic waste.

To summarize, this means that the formation of the openings in the surface of the forged half-tubes is a high-risk operation in terms of technology, time and cost in the production of the overall recuperative waste gas heat exchanger.

### SUMMARY

An example embodiment of the present invention may provide a process for the production of half-tubes or tubes of a metallic, high-temperature-resistant material with a plurality of openings passing through their surface, without the disadvantages of the processes previously employed.

According to an example embodiment of the present invention, half-tubes or tubes may be produced as high-precision casting parts by employing a precision casting process.

Such a precision casting process may provide that it combines a high reproducibility with consistently high quality and low production costs.

In order to avoid reactions between the melt and ambient gases such as oxygen, nitrogen or hydrogen, at least the casting of the melt in the mold shell may be performed in the absence of reactive gases, e.g., in vacuo, in an inert gas atmosphere, etc.

In order that also narrow cross-sections and fine contours may “run out” cleanly, the casting of the melt in hot mold shells may be performed in vacuo or under an excess pressure of inert gas.

A nickel-based alloy, e.g., IN 625, may be used as high-temperature-resistant material for the precision casting process.

According to an example embodiment of the half-tubes or tubes produced according to the process, the openings passing through the surface may have an elliptical shape. The radius of the half-tubes/tubes may be 62.5 or 37.5 mm, and the length of the half-tubes may be 500 mm or 750-900 mm.

The use of a precision casting process for the production of heat-exchanger tubes from half-tubes or tubes may provide for an inexpensive, quick and qualitatively high-grade production of such tube components.

An example embodiment of the present invention is described in more detail below with reference to the appended Figures.

### BRIEF DESCRIPTION OF THE DRAWINGS

FIG. 1 illustrates the basic structure of a recuperative waste gas heat exchanger.

FIG. 2 is a detailed view of a heat-exchanger tube.

FIG. 3 illustrates the assembly of the heat-exchanger tube illustrated in FIG. 2 from half-tubes.

### DETAILED DESCRIPTION

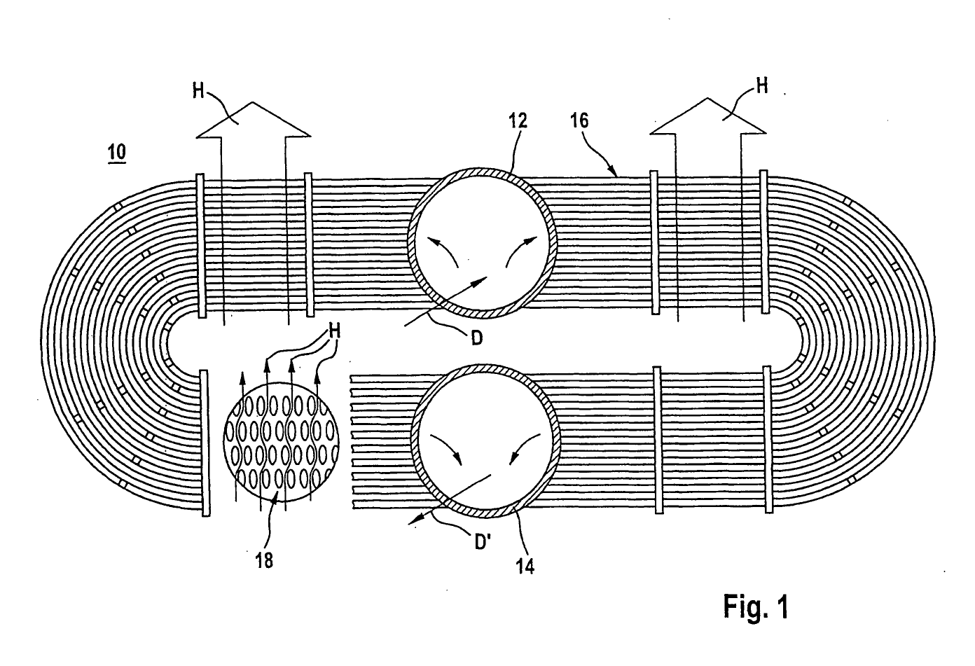

A recuperative waste gas heat exchanger of a gas turbine plant, identified overall in FIG. 1 by the reference numeral 10, includes a distributor tube 12, a collecting tube 14 arranged parallel thereto, as well as a cross-counterflow matrix 16 protruding laterally thereto in a U-shape. For simplicity, the distributor tube 12 and collecting tube 14 are identified hereinafter as heat exchanger tubes.

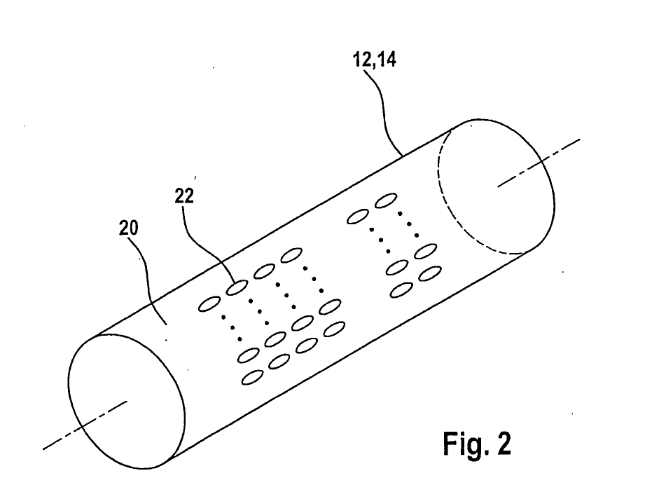

From the cross-sectional view of the cross-counterflow matrix 16 illustrated in the bottom left-hand corner of FIG. 1, it can be seen that the cross-counterflow matrix 16 includes a plurality of elliptical small tubes or lancets 18. The lancets 18 are in each case secured to the distributor tube 12 and collecting tube 14. They correspond to the openings/holes 22, not visible in this view, made for this purpose in the surface of the distributor tube 12 and the collecting tube 14 (cf. FIG. 2).

The mode of operation of the recuperative waste gas heat exchanger described hereinbefore is as follows:

Cold compressed air is fed from a compressor in the direction of the arrow D to the distributor tube 12. The cold compressed air flows from the distributor tube 12 through the openings/holes made in the surface into the laterally protruding, U-shaped cross-counterflow matrix 16. The cold compressor air is heated up by the circulating flow of the hot turbine waste gas H through the cross-counterflow matrix 16. After flowing through the cross-counterflow matrix 16 and entering the collecting tube 14, the now hot air is fed in the direction of the arrow D′ to a suitable consumer, e.g. the combustion chamber.

FIG. 2 illustrates on an enlarged scale a detailed view of a perforated heat exchanger tube 12/14 of the recuperative waste gas heat exchanger 10. The heat exchanger tube 12/14 has a plurality of openings 22 passing through its surface 20. The openings 22 are elliptical in shape. Of this large number of openings 22 in the surface 20, for clarity, only a few of the openings 22 passing through the surface 20 of the heat exchanger tube 12/14 are illustrated. For completeness, it may however be mentioned that 184 rows of holes, i.e., 3,496 openings 22, are provided per half-tube of dimensions 500 mm in length and radius 62.5 mm. A total of 2×3,496=6,992 openings 22 passing through the surface 20 are thus produced per heat exchanger tube 12/14.

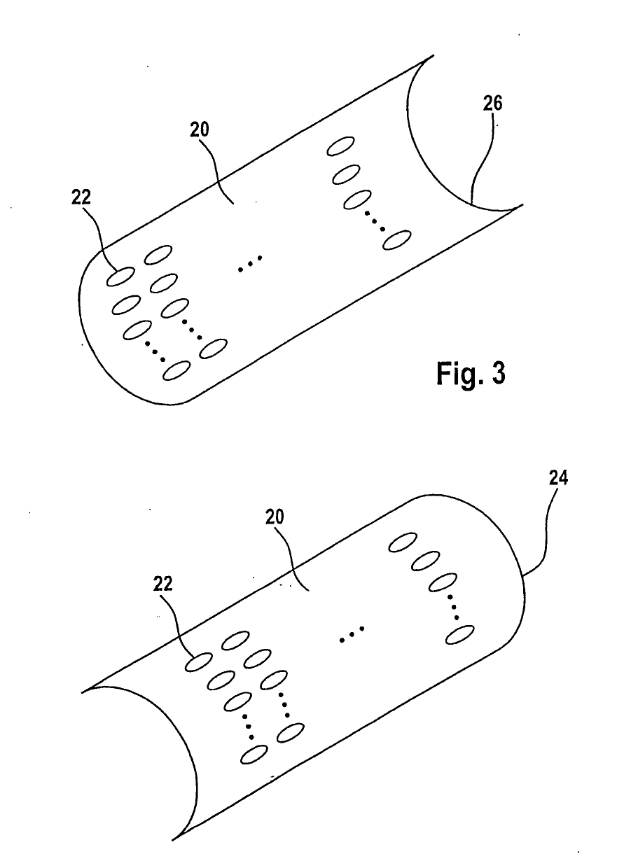

In this example, the heat exchanger tube 12/14 is, as illustrated in FIG. 3, assembled from a first half-tube 24 and a second half-tube 26. The joining of the two half-tubes 24, 26 is performed by fusion welding, and the installation of the lancets may be performed in a conventional manner by high temperature soldering.

The production of the half-tubes 24, 26 by a precision casting method is described in detail, in which the process steps—with the exception of the assembly of the half-tubes—apply in the same manner also to the production of a tube, i.e., a complete tube.

To this end, in a first process step a fine-structured, dimensionally accurate model of the half-tubes 24, 26 destroyable by heating, including the openings 22 passing through the surface 20, is first of all produced. Wax is used as the model material for this purpose.

The wax model including the wax gate system receives a mold shell by immersion in ceramic coating compositions followed by sanding with casting shell ceramics material. In order to ensure the stability of the mold shell, the automated process of immersion followed by sanding is repeated several times.

After the model has been melted, e.g., in an autoclave using superheated steam, the single-piece mold shells that are thereby formed are fired, thereby acquiring their fire resistance. This is followed by the casting of the melt into hot mold shells by employing a vacuum or under excess pressure of an inert gas.

In this manner, it may be ensured that also the narrow cross-sections between two openings 22 in the surface 20 of a half-tube 24, 26 “run out” cleanly. The melting and casting of the half-tube material is performed under a high vacuum. A nickel-based alloy with the standard reference IN 625 (INCONEL) is used as material.

The cast half-tubes 24, 26 may then be cleaned and trimmed, in which connection the sprues may also be removed. For the fabrication of the half-tubes 24, 26, a post-treatment of the openings 22 passing through the surface 20 may if necessary also be performed in a last workstage by blasting with erosive abrasives or by a “facing operation” by EDM (electrodischarge machining). Because of the high quality and tight tolerances of the precision casting method that is used, only a short processing time may be required for this purpose. The recast layers hitherto formed by producing the openings by EDM may be greatly minimized and therefore disregarded, since they may be negligibly thin and small as a result of the short processing time.

The assembly of two such half-tubes 24, 26 to form a heat exchanger tube 12/14 may be performed by a conventional fusion welding process. The introduction of the lancets made of IN 625 into the elliptical perforations is performed by a highly automated assembly and soldering operation with soldering paste by vacuum high-temperature soldering.

1-9. (canceled)

9. A process for producing one of (a) half-tubes and (b) a tube of a metallic, high-temperature-resistant material with a plurality of openings passing through a surface of the one of (a) the half-tubes and (b) the tube for fabricating heat-exchanger tubes for a recuperative waste gas heat exchanger, comprising:
forming a model, destroyable by heat, of each of the one of (a) the half-tubes and (b) the tube;
forming a mold shell by finishing with a conventional gate system and immersion of the model in a ceramic coating composition and sanding with a cast shell ceramic material, alternating in several cycles;
melting-out of the model from the mold shell;
hardening the mold shell by firing;
producing a melt from the metallic, high-temperature-resistant material;
casting the melt in the mold shell one of (a) by applying a vacuum and (b) under excess pressure of an inert gas;
removing, after solidification of the melt, the one of (a) the half-tubes and (b) the tube from the mold by destroying the mold shell;
cleaning and trimming the one of (a) the half-tubes and (b) the tube and removing a sprue; and
post-treating, as necessary, the opening passing through the surface of the one of (a) the half-tubes and (b) the tube by one of (a) spark erosion and (b) blasting with an abrasive blasting agent.

10. The process according to claim 9, wherein the model is melted out from the mold shell in the melting-out step in an autoclave.

11. The process according to claim 9, wherein the spark erosion includes electrodischarge machining.

12. The process according to claim 9, further comprising joining two half-tubes by one of (a) high-temperature soldering and (b) fusion welding to form a heat exchanger tube.

13. The process according to claim 9, wherein a material of the model includes wax.

14. The process according to claim 9, wherein the casting of the melt in the mold shell is performed in an absence of reactive gases.

15. The process according to claim 9, wherein the casting of the melt in the mold shell is performed one of (a) in vacuo and (b) under an inert gas atmosphere.

16. The process according to claim 9, wherein the casting of the melt in the mold shell includes pouring the melt into a hot mold shell.

17. The process according to claim 9, wherein the high-temperature-resistant material includes a nickel-based alloy.

18. The process according to claim 9, wherein the high-temperature-resistant material includes IN 625.

19. The process according to claim 9, wherein the openings are elliptical in shape.

20. The process according to claim 9, wherein a length of the one of (a) the half-tubes and (b) the tube is 500 mm, and a radius of the one of (a) the half-tubes and (b) the tube is 62.50 mm.

21. The process according to claim 9, wherein a length of the one of (a) the half-tubes and (b) the tube is 750 mm to 900 mm, and a radius of the one of (a) the half-tubes and (b) the tube is 37.50 mm.

22. A half-tube formed of a metallic, high-temperature-resistant material with a plurality of openings passing through a surface thereof for fabricating heat-exchanger tubes for a recuperative waste gas heat exchanger, comprising:
forming a model, destroyable by heat, of the half-tube;
forming a mold shell by finishing with a conventional gate system and immersion of the model in a ceramic coating composition and sanding with a cast shell ceramic material, alternating in several cycles;
melting-out of the model from the mold shell;
hardening the mold shell by firing;
producing a melt from the metallic, high-temperature-resistant material;
casting the melt in the mold shell one of (a) by applying a vacuum and (b) under excess pressure of an inert gas;
removing, after solidification of the melt, half-tube from the mold by destroying the mold shell;
cleaning and trimming the half-tube and removing a sprue;
post-treating, as necessary, the opening passing through the surface of the half-tube by one of (a) spark erosion and (b) blasting with an abrasive blasting agent;
wherein the openings are elliptical in shape.

23. The half-tube according to claim 22, wherein one of (a) a length of the half-tube is 500 mm, and a radius of the half-tube is 62.50 mm, and (b) a length of the half-tube is 750 mm to 900 mm, and a radius of the half-tube is 37.50 mm.

24. A tube formed of a metallic, high-temperature-resistant material with a plurality of openings passing through a surface thereof for fabricating heat-exchanger tubes for a recuperative waste gas heat exchanger, comprising:
forming a model, destroyable by heat, of the tube;
forming a mold shell by finishing with a conventional gate system and immersion of the model in a ceramic coating composition and sanding with a cast shell ceramic material, alternating in several cycles;
melting-out of the model from the mold shell;
hardening the mold shell by firing;
producing a melt from the metallic, high-temperature-resistant material;
casting the melt in the mold shell one of (a) by applying a vacuum and (b) under excess pressure of an inert gas;
removing, after solidification of the melt, tube from the mold by destroying the mold shell;
cleaning and trimming the tube and removing a sprue;
post-treating, as necessary, the opening passing through the surface of the tube by one of (a) spark erosion and (b) blasting with an abrasive blasting agent;
wherein the openings are elliptical in shape.

25. The tube according to claim 24, wherein one of (a) a length of the tube is 500 mm, and a radius of the tube is 62.50 mm, and (b) a length of the tube is 750 mm to 900 mm, and a radius of the tube is 37.50 mm.
